(19) United States
(12) Patent Application Publication
(10) Pub. No.: US 2024/0298611 A1
(43) Pub. Date: Sep. 12, 2024

(54) SERVICE ANIMAL REAL-TIME MONITORING SYSTEM

(71) Applicant: Applied Research Associates, Inc., Albuquerque, NM (US)

(72) Inventors: Dan Welsh, Lakewood, CO (US); Sarah Corniea, Denver, CO (US); Gian Cervo, Centennial, CO (US); Brian Zadler, Golden, CO (US)

(21) Appl. No.: 18/180,458

(22) Filed: Mar. 8, 2023

(51) Int. Cl. A01K 27/00

(52) U.S. Cl. CPC A01K 27/002; A01K 27/006; A01K 27/009

(57) ABSTRACT

A service animal real-time monitoring system for monitoring a location of a service animal and controlling operation of one or more light modules associated with the service animal. A user device may interface, at least indirectly, with the one or more light modules to provide control commands from a human operator to the one or more light modules and to receive location information from a GPS receiver associated with the service animal.

### BACKGROUND

### 1. Field

Embodiments of the invention relate to monitoring and tracking service animals. More specifically, embodiments of the invention relate to real-time lighting and monitoring for service animals.

### 2. Related Art

Service animals such as canines are useful assets in a variety of service situations. For example, canines may be employed in any of a range of military, law enforcement, and security operations such as reconnaissance, search and rescue, subduing enemies, explosive detection, and patrol. As such, it may be useful to track and monitor said canines in service situations for strategic purposes. However, existing means of service animal tracking fail to actively monitor and communicate information relating to the position of a service animal during operation.

### SUMMARY

Embodiments of the invention solve the above-mentioned problems by providing systems, methods, and computer-readable media for service animal real-time monitoring. Specifically, aspects of the present disclosure provide a service animal monitoring system that actively monitors and communicates information relating to the position of a service animal within an operating environment. In some embodiments, position information may be obtained using a GPS tracking means coupled to a harness or light module attached to the service animal. Additionally, in some embodiments, one or more light modules are included providing illumination for any of locating the service animal, creating a distraction, blinding a target, illuminating a target, or increasing visibility for the service animal.

In some aspects, the techniques described herein relate to a service animal real-time monitoring system including a back-mounted light module mounted on a canine harness at a back portion of the canine harness, a front-mounted light module mounted on a canine collar or mounted on the canine harness at a front portion of the canine harness, a GPS receiver disposed in the canine harness, and a transceiver disposed in the canine harness, the transceiver communicatively coupled to a user device to wireless transmit signals between the service animal real-time monitoring system and the user device, wherein the signals transmitted between the service animal real-time monitoring system and the user device include at least a control signal from the user device configured to activate at least one of the front-mounted light module and the back-mounted light module, and a GPS signal indicative of a position of the GPS receiver transmitted to the user device.

In some aspects, the techniques described herein relate to a service animal real-time monitoring system, wherein the GPS receiver is incorporated into the back-mounted light module.

In some aspects, the techniques described herein relate to a service animal real-time monitoring system, further including at least one wireless antenna coupled to the transceiver, wherein the at least one wireless antenna is flexible and tucked into the canine harness to prevent snagging.

In some aspects, the techniques described herein relate to a service animal real-time monitoring system, wherein the signals transmitted between the service animal real-time monitoring system and the user device further includes a status information signal including status information for at least one of the front-mounted light module and the back-mounted light module.

In some aspects, the techniques described herein relate to a service animal real-time monitoring system, wherein the at least one strobe light includes an infrared light and a visible light.

In some aspects, the techniques described herein relate to a service animal real-time monitoring system, wherein the control signal from the user device includes an instruction to switch between the infrared light and the visible light.

In some aspects, the techniques described herein relate to a service animal real-time monitoring system, wherein the front-mounted light module includes at least one flood light and the back-mounted light module includes at least one strobe light.

In some aspects, the techniques described herein relate to a service animal real-time monitoring system including a first light module configured to be worn by a canine, a second light module configured to be worn by the canine, a GPS receiver coupled to the first light module or the second light module, and a transceiver coupled to the first light module or the second light module, the transceiver communicatively coupled to a user device to wirelessly transmit signals between the service animal real-time monitoring system and the user device, wherein the signals transmitted between the service animal real-time monitoring system and the user device include at least a control signal from the user device configured to activate at least one of the first light module and the second light module, and a GPS signal including information indicative of a position of the GPS receiver transmitted to the user device.

In some aspects, the techniques described herein relate to a service animal real-time monitoring system, wherein the first light module includes at least one flood light and the second light module including at least one strobe light.

In some aspects, the techniques described herein relate to a service animal real-time monitoring system, wherein the second light module further includes at least one infrared light.

In some aspects, the techniques described herein relate to a service animal real-time monitoring system, wherein the signals transmitted between the service animal real-time monitoring system and the user device further include a subsequent control signal from the user device configured to selectively activate one of the at least one flood light or the at least one infrared light.

In some aspects, the techniques described herein relate to a service animal real-time monitoring system, further including one or more cameras coupled to the first light module or the second light module configured to capture video data of an operating environment of the canine.

In some aspects, the techniques described herein relate to a service animal real-time monitoring system, further including one or more speakers coupled to the first light module or the second light module.

In some aspects, the techniques described herein relate to a service animal real-time monitoring system, further including one or more microphones coupled to the first light module or the second light module configured to capture audio data of an operating environment of the canine.

In some aspects, the techniques described herein relate to a service animal real-time monitoring system including one or more light modules configured to be attached to a canine, a GPS receiver configured to be attached to the canine, and a transceiver configured to be attached to the canine, the transceiver communicatively coupled to a user device to wireless transmit signals between the service animal real-time monitoring system and the user device, wherein the signals transmitted between the service animal real-time monitoring system and the user device include at least a control signal from the user device configured to activate or adjust the one or more light modules, and a GPS signal indicative of a position of the GPS receiver transmitted to the user device.

In some aspects, the techniques described herein relate to a service animal real-time monitoring system, further including one or more speakers configured to be attached to the canine operable to playback audio.

In some aspects, the techniques described herein relate to a service animal real-time monitoring system, wherein the one or more speakers are operable to playback a high-frequency audio message that is detectable by the canine but is outside of a human audible frequency range.

In some aspects, the techniques described herein relate to a service animal real-time monitoring system, wherein the one or more light modules includes at least one infrared light.

In some aspects, the techniques described herein relate to a service animal real-time monitoring system, wherein the at least one infrared light is operable to produce an undetectable lighting pattern corresponding to a predetermined lighting pattern scheme.

In some aspects, the techniques described herein relate to a service animal real-time monitoring system, wherein the transceiver comprises an antennae configured to be tucked into a harness worn by the canine.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the invention will be apparent from the following detailed description of the embodiments and the accompanying drawing figures.

### BRIEF DESCRIPTION OF THE DRAWING FIGURES

Embodiments of the invention are described in detail below with reference to the attached drawing figures, wherein:

FIG. 1 illustrates an exemplary communication system relating to some embodiments;

FIG. 2 illustrates an exemplary system relating to some embodiments;

FIG. 3 illustrates an exemplary canine harness system relating to some embodiments;

FIG. 4A illustrates a first exemplary configuration of a service animal harness relating to some embodiments;

FIG. 4B illustrates a second exemplary configuration of a service animal harness relating to some embodiments;

FIG. 4C illustrates a third exemplary configuration of a service animal harness relating to some embodiments;

FIG. 5 illustrates an exemplary user interface relating to some embodiments; and

FIG. 6 illustrates an exemplary method for a service animal monitoring system relating to some embodiments.

The drawing figures do not limit the invention to the specific embodiments disclosed and described herein. The drawings are not necessarily to scale, emphasis instead being placed upon clearly illustrating the principles of the invention.

### DETAILED DESCRIPTION

The following detailed description references the accompanying drawings that illustrate specific embodiments in which the invention can be practiced. The embodiments are intended to describe aspects of the invention in sufficient detail to enable those skilled in the art to practice the invention. Other embodiments can be utilized and changes can be made without departing from the scope of the invention. The following detailed description is, therefore, not to be taken in a limiting sense. The scope of the invention is defined only by the appended claims, along with the full scope of equivalents to which such claims are entitled.

In this description, references to “one embodiment,”“an embodiment,” or “embodiments” mean that the feature or features being referred to are included in at least one embodiment of the technology. Separate references to “one embodiment,”“an embodiment,” or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments but is not necessarily included. Thus, the technology can include a variety of combinations and/or integrations of the embodiments described herein.

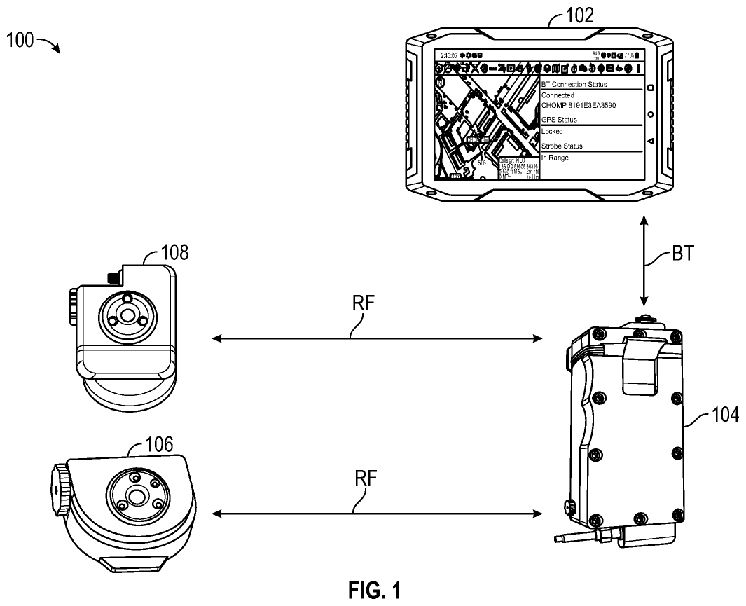

FIG. 1 illustrates an exemplary communication system 100 relating to some embodiments. The communication system 100 may be integrated into a service animal monitoring system, as will be described in further detail below, for example, to provide location monitoring and lighting control in association with a service animal deployed to an operating environment. In some such embodiments, the communication system 100 comprises a user device 102, such as a smart phone, tablet, personal computer, laptop, or other suitable mobile or desktop device. The communication system 100 may further comprise a controller module 104 configured to be wirelessly coupled to the user device 102. In some embodiments, a BLUETOOTH® connection may be established between the user device 102 and the controller module 104 to enable two-way wireless communication between the user device 102 and the controller module 104. In some cases, a Bluetooth Low Energy (BLE) connection may be used such as, for example, BLE v5.2.

In some embodiments, the BLUETOOTH connection provides bidirectional communication between the user device 102 and the controller module 104. Accordingly, operating data such as any of location data, lighting status data, battery status data, or other suitable data relating to operation of the service animal monitoring system may be sent from the controller module 104 to the user device 102. Additionally, in some embodiments, user commands and other inputs may be sent from the user device 102 to the controller module 104 via the BLUETOOTH connection, such that a user may provide commands using the user device 102 that are communicated to the controller module 104.

In some embodiments, the communication system 100 further comprises one or more light modules, such as a front-mounted light module 106 and a back-mounted light module 108 configured to be mounted to a canine harness worn by a service animal. In some embodiments, each of the light modules 106 and 108 may include a different type of light. For example, the front-mounted light module 106 may include at least one flood light configured to provide high visibility illumination in front of a canine, and the back-mounted light module 108 may include at least one strobe light configured to flash with a strobe pattern to alert a human operator or others to the location of the canine.

In some embodiments, an independent communication connection may be established with the controller module 104 and each of the front-mounted light module 106 and the back-mounted light module 108. Alternatively, in some embodiments, a communication connection with the controller module 104 may be shared by the light modules 106 and 108. Further, embodiments are contemplated in which communication may be established between the light modules 106 and 108 and the controller module 104 using either of a wireless or wired connection. In some embodiments, a direct radio frequency communication connection is established between the controller module 104 and each respective light module permitting wireless communication with the controller module 104.

The radio frequency connection may be used to communicate a variety of different signals between the controller module 104 and the light modules 106 and 108. For example, in some embodiments, the radio frequency transmits a lighting control signal from the controller module 104 to one of the light modules 106 and/or 108 operable to activate or adjust one or more lights of the respective light module. Additionally, in some embodiments, the radio frequency connection provides bidirectional communication such that signals may be transmitted from the light modules 106 and 108 to the controller module 104. For example, any of a location indication signal, a lighting status signal, an update signal, or a battery status signal may be transmitted from the light modules 106 or 108 to the controller module 104.

In some embodiments, the radio frequency communication connections may be selected at a frequency to permit short to medium range communication with the controller module 104 within the service area. For example, the radio frequency communication connection may be operable to wirelessly transmit information up to about 1 mile or a few miles. However, it should be understood that shorter and longer ranges are also contemplated. In some embodiments, a particular type of point-to-point radio frequency connection is used that utilizes a specific frequency range that is optimized for a specific short to medium range and prevents interference with commonly used frequencies that are included in other forms of radio communication.

In some embodiments, one or more signal repeaters may be included within an operating environment, for example, to increase a range of the communication connections described herein. For example, in some embodiments, a drone or other remote mobile system may be deployed to the operating environment to receive and repeat/boost a wireless communication signal between any of the user device 102, the controller module 104, the front-mounted light module 106, and the back-mounted light module 108. Additionally, or alternatively, one or more static signal repeater devices may be deployed in the operating environment ahead of time or during operation to enhance the communication signals. In some such embodiments, the use of signal repeaters may extend the overall range of the communication signals, increase the overall readability of the signals, or to allow the communication signals to be received on the other side of an obstacle or obstruction within or outside of the operating environment.

The controller module 104 may include any number of buttons, switches, dials, or other actuatable controls for receiving user inputs from a human operator. The user inputs received into the controller module 104 may be configured to activate or adjust the one or more light modules 106 and 108. For example, operator inputs may be received into the controller module 104 requesting to adjust which light modules are activated. Alternatively, or additionally, user inputs may be received into the user device 102, for example, via a touch screen, and routed through the controller module 104 to the one or more light modules 106 and 108. Further still, embodiments are contemplated in which a communication connection may be established directly between the user device 102 and the light modules 106 and 108, such that inputs may be transmitted directly from the user device 102 and operational data is received directly from the light modules 106 and 108.

In some embodiments, the communication system 100 provides transfer of real-time data relating to the operating environment. For example, real-time geolocation data may be received by a GPS receiver coupled to one of the light modules 106 and 108 and displayed within an interface of the user device 102. Similarly, real-time system data relating to any of the controller module 104, the light module 106, and the light module 108 may be communicated to the user device 102 and displayed within a user interface of the user device 102.

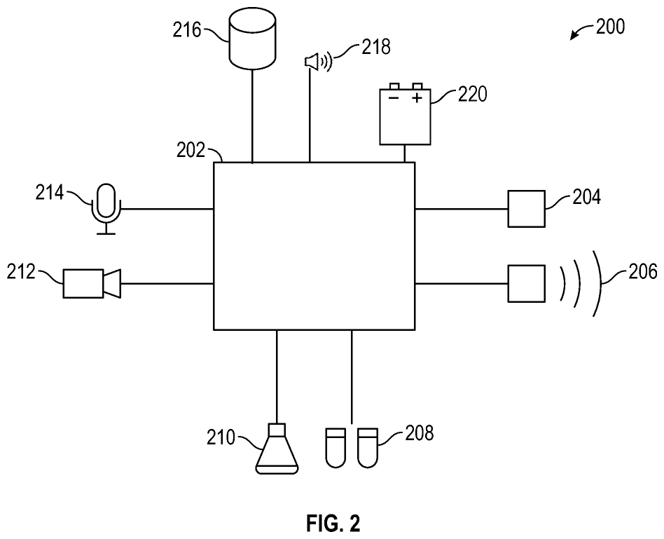

FIG. 2 illustrates an exemplary system 200 relating to some embodiments. The system 200 may give an example of components that may be incorporated into or coupled with an exemplary light module, such as either of the front-mounted light module 106 and the back-mounted light module 108. In some embodiments, the system 200 comprises a controller portion 202, as shown. The controller portion 202 may include at least one processor for processing information and executing operations of the system 200.

The system 200 may further comprise a Global Positioning System (GPS) receiver 204 coupled to the controller portion 202, as shown. The GPS receiver 204 may receive GPS signals from a plurality of GPS satellites to determine positioning information of the system 200. In some embodiments, the system 200 further comprises a radio frequency transceiver 206 coupled to the controller portion 202 for receiving and transmitting radio frequency signals wirelessly. In some embodiments, the radio frequency transceiver 206 may be configured to transmit and receive radio frequency communications to and from the controller module 104, as described above. Accordingly, the controller portion 202 may activate or deactivate one or more components of the system 200 based on signals received from the controller module 104 by the radio frequency transceiver 206.

The system 200 may further comprise one or more lights 208, as shown. In some embodiments, the one or more lights 208 are configured to provide lighting within the visible light spectrum as opposed to that of ultraviolet and infrared light. Accordingly, during operation, the one or more lights 208 may provide illumination to a surrounding environment of the canine such that the canine is able to see and/or such that an operator can locate the canine. In some embodiments, one or more infrared lights 210 are also included. For example, embodiments are contemplated in which a lighting mode may be selected between a standard lighting mode and an infrared lighting mode. Accordingly, the one or more infrared lights 210 are used to provide a covert lighting beacon that may be exclusively visible to an infrared sensor, such as an infrared night vision device, as to not alert enemies or bystanders to the location of the canine. In some embodiments, one or more ultraviolet lights may be included. In some such cases, the ultraviolet lights may provide lighting that is only visible to canines and is outside of the visible light spectrum for human eyes. Further, in some embodiments, the one or more light modules may include blue lights catered to the canine vision, which is relatively more sensitive to changes in blue light.

In some embodiments, the one or more lights 208 may be operable to provide illumination in a variety of different colors. For example, lighting can be selectively adjusted between any suitable color to convey information to other operators or to the canine. Accordingly, embodiments are contemplated in which a color-coded messaging scheme may be used to covertly communicate messages using the service animal monitoring system. For example, a green light may correspond to an affirmative message, a yellow light may correspond to a caution message, and a red light may correspond to a danger message. Similarly, messages may be conveyed using different light flashing frequencies and patterns and, in some embodiments, messages may be communicated covertly using infrared or ultraviolet light patterns that are not visible or undetectable to humans. For example, a flash pattern of the one or more infrared lights 210 may be used to convey a message in morse code or in coordination with another suitable encoded communication pattern scheme. In such embodiments, one or more human operators may be equipped with devices capable of sensing the infrared or ultraviolet light patterns to detect and decipher messages that are presented by the service animal monitoring system within a predetermined lighting pattern scheme.

In some embodiments, at least one camera 212 may be included as part of the system 200, as shown. The at least one camera 212 may be operable to record video data of the environment of the canine. In some embodiments, the at least one camera 212 may be small or hidden within the canine harness such that the camera 212 is not noticeable to enemies or bystanders. Additionally, a microphone 214 may be included, which may be coupled to the camera 212. The microphone 214 may be configured to record audio data of the environment of the canine. Accordingly, the system 200 may be used to covertly gather intelligence information in the form of video and audio data. Additionally, the video and audio data may be authenticated as unalterable video data such that it may be utilized as evidence in court proceedings.

In some embodiments, a storage 216 may be included in the system 200 operable to store data captured by the system 200. For example, data recorded by either of the camera 212 or the microphone 214 may be stored in the storage 216. In some embodiments, data from the camera 212 and/or the microphone 214 may be transmitted to the controller module 104 or the user device 102 via the radio frequency transceiver 206.

In some embodiments, the system 200 may include any number of additional devices or components. For example, in some embodiments, one or more speakers 218 may be included for optionally producing an audible alarm or other sound. In some such embodiments, the speakers 218 may be used to create a distraction or to immediately alert a human operator to the position of the service animal. Similarly, the speakers 218 may be used to provide an audible message to other humans in the vicinity of the canine. For example, a warning or other type of message may be conveyed over the speakers 218 to one or more enemies, friendly operators, or non-combatants near the canine.

Additionally, embodiments are contemplated in which the speakers may be used to provide audible playback of a message or to transmit a human operator's voice in real-time. For example, a human operator may speak into the user device 102 and the audio signal may be transmitted through the controller module 104 and played over the one or more speakers 218 in the location of the service animal. As such, embodiments are contemplated in which the one or more speakers 218 may be used to provide audible commands to the service animal. Accordingly, a canine trained to respond to audible commands from a human operator may receive audible commands remotely from a human operator within another location in the operating environment or within an external location. For example, the human operator may submit a command into a microphone of the user device 102 requesting that the canine return to a rendezvous point. The rendezvous command is wirelessly transmitted to the portion of the service animal monitoring system worn by the canine and played over the one or more speakers 218 such that the canine hears the command and returns to the rendezvous point.

Further embodiments are contemplated in which the one or more speakers 218 are able to produce sounds that are inaudible to humans. A human audible frequency range is typically between 20 Hz and 20 kHz, while a canine audible frequency range is typically between 40 Hz and 60 kHz. Accordingly, in some embodiments, audio messages may be played back over the one or more speakers 218 at a frequency between about 20 kHz and 60 kHz such that the audio exceeds the audible range of humans and is still audible to the canine (or other service animal). For example, high-frequency speakers may be included such that high-frequency commands may be transmitted to the canine without alerting enemies or non-combatants in the vicinity of the canine. Accordingly, the canine may be trained to respond to commands at frequencies outside of the range of human detection such that commands may be covertly communicated to service animals. Additionally, in some embodiments, friendly human operators may be equipped with a device capable of sensing and translating these high frequencies such that messages may be communicated to other operators without being detected by enemies or non-combatants.

In some embodiments, at least one power source 220 may be included or interfaced with. For example, an external battery may be incorporated into a canine harness that interfaces with one or more light modules or other components. Additionally, or alternatively, in some embodiments, a battery may be included within each light module. In some such embodiments, the radio frequency transceiver 206 may be operable to transmit a battery status signal indicative of a current battery level of the power source 220.

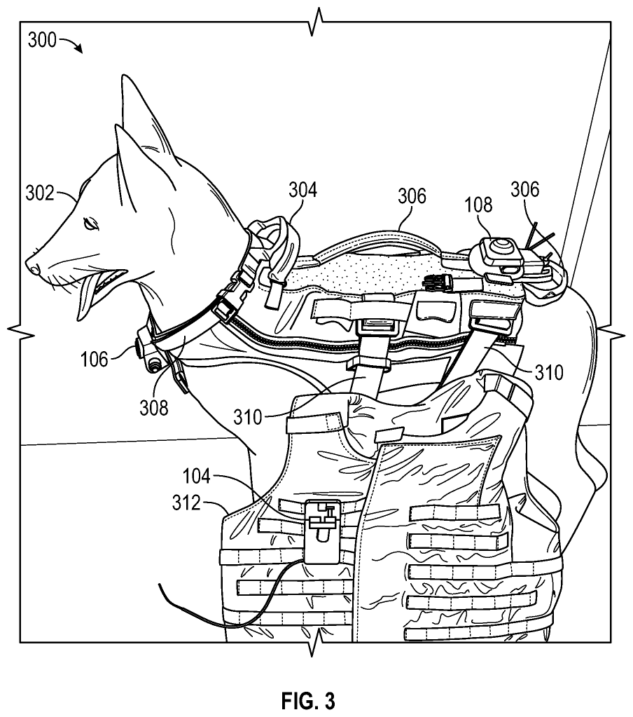

FIG. 3 illustrates an exemplary canine harness system 300 relating to some embodiments. The canine harness system 300 may be adapted to be worn by a canine 302, as shown. In some embodiments, the canine harness system 300 includes a harness 304 configured to be worn by the canine 302 during use, as shown. One or more handles 306 may be included on the harness 304, as shown. For example, a first handle may be disposed at a top of the harness 304 and a second handle may be disposed at a back of the harness 304. In some embodiments, a collar portion 308 may be included on or coupled to the harness 304. The collar portion 308 may be adapted to be worn over a neck of the canine 302, as shown. Additionally, one or more straps 310 may be included on the harness 304, as shown. In some embodiments, the straps 310 may be configured to tighten the harness to the canine 302.

In some embodiments, the front-mounted light module 106 may be secured to the collar portion 308, as shown. Similarly, the back-mounted light module 108 may be secured to a back portion of the harness 304. In some such embodiments, any of the front-mounted light module 106 and the back-mounted light module 108 may be removably secured to the harness 304 using a suitable removable fastening means. For example, the light modules 106 and 108 may be secured using straps, clips, hooks, buttons, or other forms of selectively removable fastening. In some such embodiments, the light modules 106 and 108 may be secured to the harness 304 using a fastening means that can withstand the rugged operation of the canine. For example, the light modules may be secured and positioned such that they are prevented from being unintentionally removed or snagging on external objects. The light modules 106 and 108 may include rounded edges to further prevent snagging.

In some embodiments, a vest 312 may be included configured to be worn by a human operator. The controller module 104 may be removably secured to the vest 312, as shown, for example by securing a clip disposed on a back side of the controller module 104 to a strap disposed on the vest 312. Alternatively, in some cases, the controller module 104 may be placed in a pocket or held by the human operator.

In some embodiments, any of the components described with respect to the harness 304 or the vest 312 may be waterproof such that the canine is permitted to travel through environments where water is present or during rainfall without affecting the sensitive electronic portions of various components. For example, in some embodiments, the components may be selected with a minimum waterproof rating associated with a typical swimming depth of the canine. For example, components with a light pressure to high pressure water-proof rating may be used such that the components are resistant to rain fall, moisture, and submersion up to a suitable depth of pressure. In some such embodiments, water-proofing may be provided by sealing the housings of the electrical components and other sensitive components. Additionally, in some embodiments, a water-proof bag or water-proof compartment may be included on or along with the harness 304 to safely store other sensitive objects. For example, a water-proof compartment on the harness 304 may be used to transport and/or conceal sensitive INTEL or evidence obtained from the operating environment.

Additionally, in some embodiments, one or more components of the harness 304 may be physically reinforced or strengthened to increase the durability of the canine harness system 300. In some cases, the durability of the components may be increased by selecting robust materials that can withstand the wear associated with the operating environment of the canine. In some cases, using components comprising durable materials prevents said components from being damaged during operations of the canine such as jumping, falling, digging, crawling through holes and tight spaces, and sprinting.

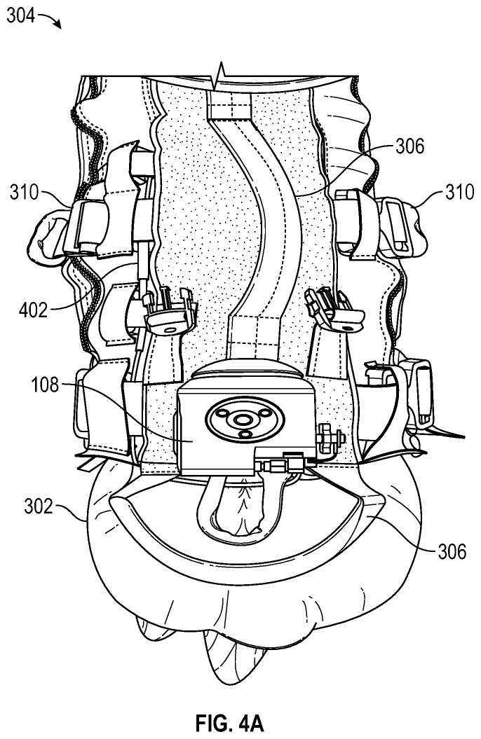

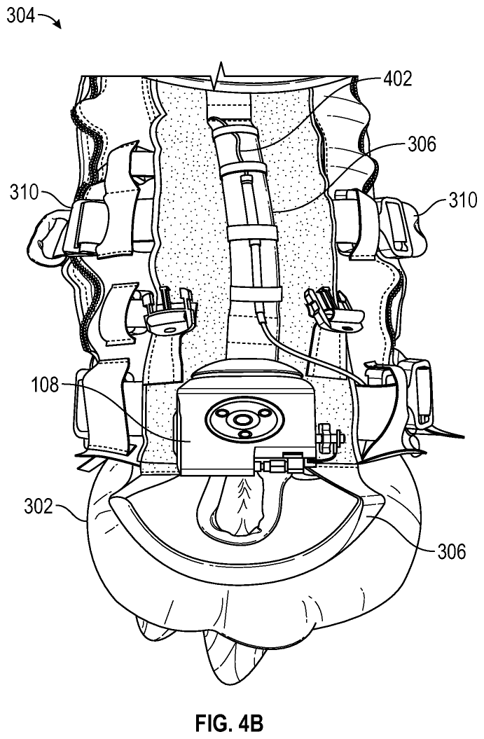

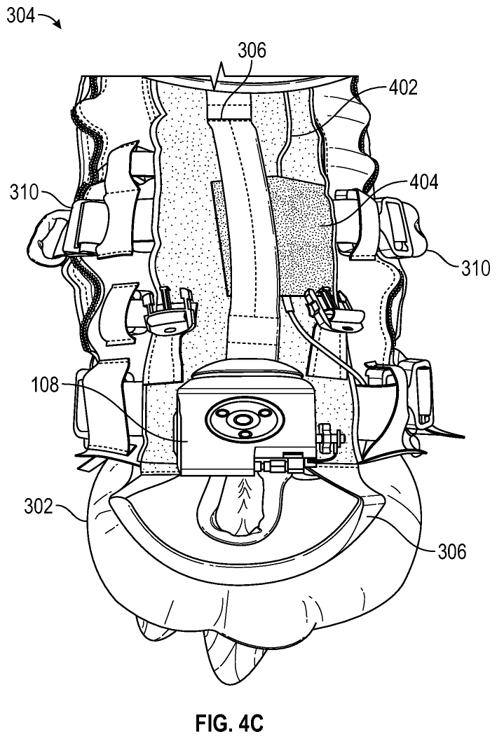

FIGS. 4A-4C illustrate the exemplary harness 304 with an antennae 402 relating to some embodiments. In some such embodiments, various different configurations for securing and positioning the antennae 402 are contemplated, for example, to prevent the antennae 402 from snagging on or being damaged by foreign objects. FIG. 4A illustrates an exemplary configuration of the harness 304 in which the antennae 402 is tucked into a side portion of the harness 304, as shown. For example, in some embodiments, the antennae 402 may be routed through the one or more straps 310 such that the antennae 402 is prevented from coming loose or snagging on external objects such as tree branches. In some embodiments, the antennae 402 comprises a long flexible structure such that the antennae 402 is capable of being folded and routed into a variety of different configurations.

FIG. 4B illustrates an exemplary configuration of the harness 304 in which the antennae 402 is routed along the handle 306, as shown. Here, the antennae 402 may be routed through one or more loops disposed along the handle 306 to secure the antennae 402 in place and prevent the antennae 402 from snagging on foreign objects. In some such embodiments, placing the antennae 402 at a top portion of the harness 304 such as on the handle 306 increases the reception of the antennae 402.

FIG. 4C illustrates an exemplary configuration of the harness 304 in which the antennae 402 is tucked under a hook and loop fabric patch 404 disposed on a side of the harness 304, as shown. In some such embodiments, the hook and loop fabric patch 404 is removably secured to the harness 304 via a hook and loop fastening connection, such as Velcro®. By tucking the antennae 402 under the hook and loop fabric patch 404 the antennae 402 is prevented from snagging on foreign objects or coming loose from the harness 304.

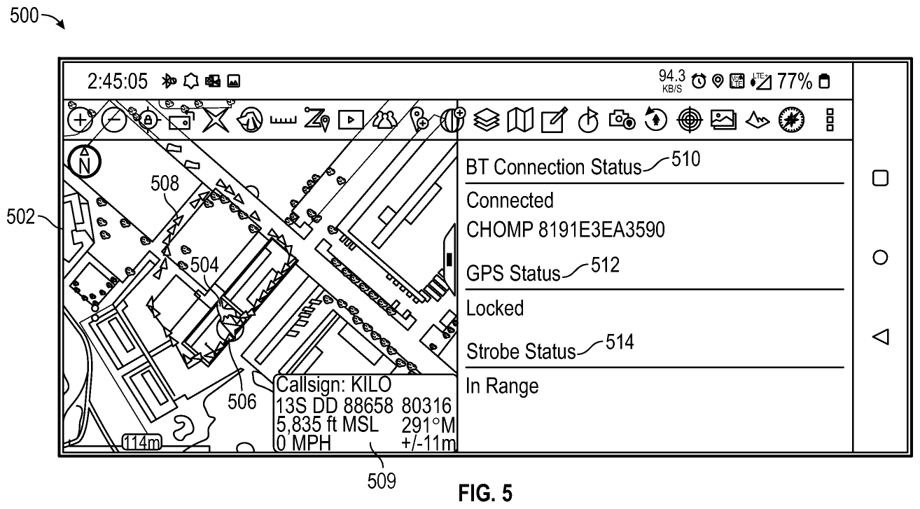

FIG. 5 illustrates an exemplary user interface 500 relating to some embodiments. In some embodiments, the user interface 500 may be associated with an application running on the user device 102. For example, embodiments are contemplated in which the Android Team Awareness Kit or Android Tactical Assault Kit (ATAK) or a similar application may be used to present the user interface 500 described herein. In some such embodiments, the ATAK software may be integrated with the service animal monitoring system to present additional information based on the service animal monitoring system. In some embodiments, the user interface 500 includes a graphical representation 502 of an operating environment. For example, the graphical representation 502 may include a top-down view of the operating environment. In some embodiments, any number of additional interface elements may be overlayed onto the graphical representation 502.

In some embodiments, the graphical representation 502 includes a service animal location indication 504 showing a current position of the service animal within the operating environment. In some embodiments, the service animal location indication 504 may also indicate a current orientation of the service animal. The orientation of the service animal may be determined based on any combination of GPS data and accelerometer data. For example, one or more accelerometers may be included on the canine harness 304 to calculate a current orientation or a change in orientation of the canine. However, it should be understood that, in some embodiments, any suitable orientation determining sensor may be used. In some such embodiments, the orientation of the service animal may be used to infer where a point of interest or alert is relative to the service animal. For example, if the service animal location indication 504 of a canine is oriented toward the North it can be inferred that the canine has been alerted to an object or event that is North of the canine's position.

Additionally, embodiments are contemplated in which advantage can be taken of the vastly superior sense of smell of the canine based on the orientation of the canine. For example, if the canine is found to be facing in a particular direction it may be inferred that the canine smells something in that direction. Accordingly, the canine's orientation may be used to determine or estimate the location of an item or substance of interest such as, for example, an explosive device, illegal drugs, or another object that the canine is searching for.

Additionally, an operator location indication 506 may be included showing a current position of the human operator within the operating environment. In some such embodiments, the service animal location indication 504 and the operator location indication 506 may be updated periodically or based on an identified change in the location of the service animal or the human operator respectively. Additionally, in some embodiments, path indicators 508 may be included showing previous positions of the service animal over time such that the operator is able to view what areas the service animal has visited within the operating environment. In some cases, recording and preventing the position of the service animal over time using the path indicators 508 may be useful for search and reconnaissance missions to convey what portions of the operating environment have been inspected.

In some embodiments, additional service animal information 509 may be overlayed onto the graphical representation 502, as shown. For example, the service animal information 509 may include any of a service animal callsign, a service animal identifier, location coordinates of the service animal, a current orientation direction of the service animal, and a current speed of the service animal.

The user interface 500 further comprises one or more parameters associated with the service animal monitoring system. For example, in some embodiments, the user interface 500 includes a connection status 510, a GPS status 512, and a strobe light status 514. However, it should be understood that a variety of other parameters relating to the service animal monitoring system not explicitly described herein may be included.

In some embodiments, the user interface 500 is configured to receive one or more operator inputs. For example, the user interface 500 may receive touch inputs, keyboard inputs, and other user inputs into the user device 102. In some such embodiments, the inputs may be communicated from the user device 102 through the controller module 104 or directly to the light modules 106 and 108. In some embodiments, user inputs received in the user interface 500 are operable to activate and adjust parameters of the one or more light modules 106 and 108. For example, a user may submit an activation command into the user interface 500 as a touch screen input that results in activation of the one or more light modules 106 and 108.

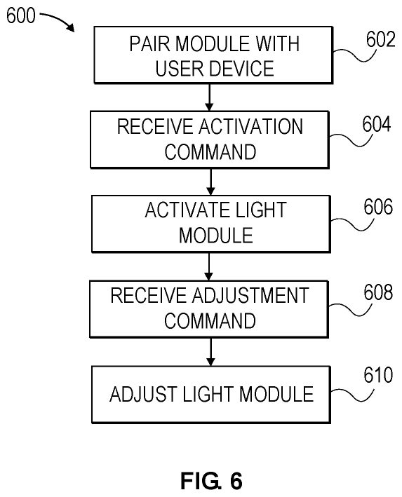

FIG. 6 illustrates an exemplary method 600 for the service animal monitoring system relating to some embodiments. In some such embodiments, the method may be carried out at least partially using one or more processors. For example, processors of the user device 102, the controller module 104, or the controller portion 202 perform various steps of the method 600.

At step 602, the controller module 104 is communicatively paired to the user device 102. In some embodiments, a BLUETOOTH® connection may be established between the controller module 104 and the user device 102. However, in some embodiments, other forms of communication are contemplated such as other forms of radio communication or other suitable wireless communication techniques. Additionally, a communication connection is established between the controller module 104 and one or more of the light modules 106 and 108.

At step 604, an activation command is received. In some embodiments, the activation command is received from either of the user device 102 or the controller module 104. The activation command may include an instruction to activate one or more lights of the light modules or to adjust the one or more lights. For example, in some cases, the activation command may be received as a user input into the user device 102 and is then transmitted through the controller module 104. Alternatively, or additionally, the activation command may be received directly into the controller module 104. For example, the controller module 104 may include one or more buttons, dials, or other actuatable controls allowing a human operator to provide user inputs using the controller module 104. In some embodiments, the activation command is configured to activate one or more lights or other functional features of the service animal monitoring system.

At step 606, at least one functionality of the service animal monitoring system is activated responsive to the activation command. For example, one or more of the light modules 106 and 108 may be activated responsive to an activation command requesting to activate the light modules. In some embodiments, at step 607, an activation response is returned from the light modules indicative of a successful activation of the respective light module. For example, a signal indicative of successful activation of the light module may be transmitted from the light module back to the controller module 104 and may cause a haptic vibration response or other notification to the user to confirm that the activation command was received and successfully carried out.

At step 608, an adjustment command is received requesting to adjust a feature or functionality of the service animal monitoring system. For example, the human operator may submit the adjustment command as a user input into either of the user device 102 or the controller module 104. The adjustment command may be configured to adjust any of the lighting type, lighting power, activation of various different light modules, or adjustments to any other feature of the service animal monitoring system.

At step 610, the adjustment is applied to the service animal monitoring system responsive to the adjustment command. For example, one or more of the light modules 106 or 108 may be adjusted to activate different lighting types (switching between visible light and infrared or ultraviolet), switching light modules, adjusting the lighting power or brightness, as well as other suitable adjustment to the lighting or other features of the service animal monitoring system.

In some embodiments, at step 612, an activation response may be returned from the light modules, similar to as described above with respect to step 607. Here, the activation response may confirm that the received adjustment command was successfully received and that the adjustment was carried out on the respective light module. It should be understood that the activation response may comprise any suitable form of notification to the user such as any one or combination of haptic feedback, audible feedback, or visual feedback. As such, the user can confirm whether the commands input into controller module 104 or user device are successfully communicated and an implemented on the light modules based on the activation response. The haptic feedback, as referred to herein may include any form of vibration pattern such as, for example, three short vibrations indicating that a light has been activated, or one long vibration indicating that a light has been deactivated. Further, in some embodiments, a plurality of different haptic feedback patterns are contemplated that correspond to a respective plurality of operations of the light modules. Accordingly, the user may be informed of a particular status of the light modules based on the specific haptic feedback pattern of the activation response.

It should be understood that, in some embodiments, any of the steps described above with respect to method 600 may be repeated or performed in a different order. Additionally, embodiments are contemplated in which any number of additional steps may be added to the method 600. For example, an additional step including receiving a subsequent command or control signal may be included and action may be taken responsive to said command or control signal.

Although the invention has been described with reference to the embodiments illustrated in the attached drawing figures, it is noted that equivalents may be employed and substitutions made herein without departing from the scope of the invention as recited in the claims.

Having thus described various embodiments of the invention, what is claimed as new and desired to be protected by Letters Patent includes the following:

1. A service animal real-time monitoring system comprising:
a back-mounted light module mounted on a canine harness at a back portion of the canine harness;
a front-mounted light module mounted on a canine collar or mounted on the canine harness at a front portion of the canine harness;
a GPS receiver disposed in the canine harness; and
a transceiver disposed in the canine harness, the transceiver communicatively coupled to a user device to wirelessly transmit signals between the service animal real-time monitoring system and the user device,
wherein the signals transmitted between the service animal real-time monitoring system and the user device comprise at least:
a control signal from the user device configured to activate at least one of the front-mounted light module and the back-mounted light module; and
a GPS signal including information indicative of a position of the GPS receiver transmitted to the user device.

2. The service animal real-time monitoring system of claim 1, wherein the GPS receiver is incorporated into the back-mounted light module.

3. The service animal real-time monitoring system of claim 1, further comprising:
at least one wireless antenna coupled to the transceiver, wherein the at least one wireless antenna is flexible and tucked into the canine harness to prevent snagging.

4. The service animal real-time monitoring system of claim 1, wherein the signals transmitted between the service animal real-time monitoring system and the user device further comprises:
a status information signal comprising status information for at least one of the front-mounted light module and the back-mounted light module.

5. The service animal real-time monitoring system of claim 1,
wherein the back-mounted light module comprises at least one infrared light and at least one visible light.

6. The service animal real-time monitoring system of claim 5,
wherein the control signal from the user device comprises an instruction to switch between the at least one infrared light and the at least one visible light.

7. The service animal real-time monitoring system of claim 1, wherein the front-mounted light module comprises at least one flood light and the back-mounted light module comprises at least one strobe light.

8. A service animal real-time monitoring system comprising:
a first light module configured to be worn by a canine;
a second light module configured to be worn by the canine;
a GPS receiver coupled to the first light module or the second light module; and
a transceiver coupled to the first light module or the second light module, the transceiver communicatively coupled to a user device to wireless transmit signals between the service animal real-time monitoring system and the user device,
wherein the signals transmitted between the service animal real-time monitoring system and the user device comprise at least:
a control signal from the user device configured to activate at least one of the first light module and the second light module; and
a GPS signal indicative of a position of the GPS receiver transmitted to the user device.

9. The service animal real-time monitoring system of claim 8, wherein the first light module comprises at least one flood light and the second light module comprising at least one strobe light.

10. The service animal real-time monitoring system of claim 9, wherein the second light module further comprises at least one infrared light.

11. The service animal real-time monitoring system of claim 10, wherein the signals transmitted between the service animal real-time monitoring system and the user device further comprise:
a subsequent control signal from the user device configured to selectively activate one of the at least one flood light or the at least one infrared light.

12. The service animal real-time monitoring system of claim 8, further comprising:
one or more cameras coupled to the first light module or the second light module configured to capture video data of an operating environment of the canine.

13. The service animal real-time monitoring system of claim 8, further comprising:
one or more speakers coupled to the first light module or the second light module.

14. The service animal real-time monitoring system of claim 8, further comprising:
one or more microphones coupled to the first light module or the second light module configured to capture audio data of an operating environment of the canine.

15. A service animal real-time monitoring system comprising:
one or more light modules configured to be attached to a canine;
a GPS receiver configured to be attached to the canine; and
a transceiver configured to be attached to the canine, the transceiver communicatively coupled to a user device to wireless transmit signals between the service animal real-time monitoring system and the user device,
wherein the signals transmitted between the service animal real-time monitoring system and the user device comprise at least:
a control signal from the user device configured to activate or adjust the one or more light modules; and
a GPS signal indicative of a position of the GPS receiver transmitted to the user device.

16. The service animal real-time monitoring system of claim 15, further comprising:
one or more speakers configured to be attached to the canine operable to playback audio.

17. The service animal real-time monitoring system of claim 16, wherein the one or more speakers are operable to playback a high-frequency audio message that is detectable by the canine but is outside of a human audible frequency range.

18. The service animal real-time monitoring system of claim 15, wherein the one or more light modules comprises at least one infrared light.

19. The service animal real-time monitoring system of claim 18, wherein the at least one infrared light is operable to produce an undetectable lighting pattern corresponding to a predetermined lighting pattern scheme.

20. The service animal real-time monitoring system of claim 15, wherein the transceiver comprises an antennae configured to be tucked into a harness worn by the canine.
